(19) United States
(12) Patent Application Publication
(10) Pub. No.: US 2008/0173728 A1
(43) Pub. Date: Jul. 24, 2008

(54) High-solids, reactive components spray application systems

(76) Inventor: Patrick Ilfrey, White Bear Lake, MN (US)

Correspondence Address: Christopher J. Whewell;Western Patent Group, 6020 Tonkowa Trail, Georgetown, TX, 78628, US

(21) Appl. No.: 11/656,112

(22) Filed: Jan. 22, 2007

(51) Int. Cl. B05B 7/00

(52) U.S. Cl. 239/74; 427/427.4

(57) ABSTRACT

Provided herein is a system useful for producing polymeric coatings on substrates, by means of a spray that is produced from impinging a compressed gas on a mixture that comprises an organic polyisocyanate and an isocyanate-reactive component. When a coating is produced from two components in accordance with the invention, each component is metered to an atomizing nozzle through peristaltic pumps, which enable increased control over flow characteristics as compared with prior art methods, and which importantly also enables greatly-reduced levels of wasted chemical components and attendant alleviated need for the use of volatile or expensive solvents in equipment cleaning operations. Uncured coating precursor material is allowed greater residence time on the target substrate prior to final cure using a system an process of the invention, which results in coatings having greater integrity over those produced using prior art equipment and methods, as well as reduced overall cost.

### TECHNICAL FIELD

This invention relates generally to polymeric coatings. More particularly, it relates to polymeric coatings which are produced by providing a surface with a reactive mixture that is capable of curing and forming a durable coating.

### BACKGROUND

Coatings for architectural structures have been in widespread use for centuries, with coats of paint applied to wood or stone being exemplary of simple coatings. With the advent of phosgenation of polyamines to produce polyisocyanates in the 1900's, the fields of polyurethane and polyurea chemistry were opened, yielding a wide range of materials which form the basis for many of today's highly-engineered architectural coatings.

Exemplary of one group of such coatings are polyurea coatings, which are often applied to floors, walls, railroad cars, truckbeds, and other surfaces, as is known in the art. Polyureas are known to be produced by the reaction which ensues upon the admixture of one or more polyisocyanates with one or more polyamines.

In general, the means for providing a mixture from which a polyurea may result is to mix a first isocyanate-containing component with a second isocyanate-reactive (polyamine-containing) component. It is common for those in the art to refer to the isocyanate containing component as the “A” side, and for the isocyanate-reactive component to be referred to as the “B” side. Once mixed, the reaction between these materials is very fast, and for this reason formulators will often add chemical agents to either of the components to hinder the reaction to some extent, to enable the mixture to be spread onto the desired surface. Those skilled in the art generally define the amount of time between the mixing of the components and the point at which the material can no longer be “worked” as the pot life time. More precise terms such as “gel time” and “cure time” are employed as well, but from the practical standpoint of applying the reactive mixture, the critical parameter is the pot life. This is especially true for those instances where a floor coating is to be applied, in which the components are mixed in a pail, bucket, or other vessel and subsequently manually spread on the surface to be coated prior to the expiration of the pot life of the material.

An alternative means for providing a polyurea coating on a surface is by the use of spray technology, which is exemplified by U.S. Pat. Nos. 5,013,813; 5,124,426; 5,266,671; 5,442,034; 5,480,955; 5,504,181; 5,616,677; 5,731,397; 6,399,736; 6,797,798; and 7,078,475. Processes according to these teachings in the prior art typically employ two-component, high pressure, airless, impingement mixing systems of the types marketed by Gusmer of Lakewood, N.J. or the Graco company. While initial investment for such systems can be on the order of $25,000 and upwards, another disadvantage is that these systems comprise pumps whose internal components and elements come into direct contact with the chemical components used in producing the final coating composition. Additionally, such systems are typically large and bulky. These combined features make it cumbersome for an operator to change chemistries of the coating or polymeric precursor being produced by the admixture of an isocyanate with an isocyanate-reactive material, such as a polyamine, polyol, etc. This difficulty in changing chemistries which results inherently from the nature of the prior art equipment also applies to those cases where the operator desires to change the color of the material being made. For these instances, each of the lines for the A and the B components must be cleaned, flushed, and dried after using one raw material and prior to the use of a second set of raw materials. This often entails the use of volatile and expensive solvents, which are not only costly but must also be handled and disposed of in environmentally-compliant ways. The time investment for such flushings is a source of added cost of applying architectural and other polyurea coatings on an industrial scale.

Thus, if a system for providing polymeric coatings and the like from a pair of mutually-reactive components had a relatively low up-front cost and did not require thorough flushing of the equipment components when a change in color or raw material were desired were available, such a system would likely be welcome in the marketplace by virtue of elimination of the undesirable aspects of the current state-of-the-art equipment and processes. The present invention provides such a system, having these and other advantages over current state-of-the-art coating-producing equipment.

### SUMMARY OF THE INVENTION

The present invention provides a system useful for providing coatings to surfaces. A system according to the invention comprises a mixer means having an interior space of any shape or dimension, a first mixer inlet, and a second mixer inlet. The mixer means is adapted to receive two separate chemical feeds and enable their admixture within the interior space. The mixer further comprises a mixer outlet. There is also a first component metering system which includes a first component reservoir having an interior. There is a first peristaltic pump means, comprising a first tube having an inlet end and an outlet end. There is also a first peristaltic pump head sufficiently disposed along the length of said first tube, between its inlet end and said outlet end, so that when the first peristaltic pump head is operational, it causes the fluid present in the interior of that portion of the first tube that is disposed between the first peristaltic pump head and the inlet end of the first tube to exist at a first pressure, and simultaneously causes the fluid present in the interior of the portion of the first tube that is disposed between the first peristaltic pump head and the outlet end of the first tube to exist at a second pressure that is higher than the first pressure. The inlet end of the first tube is in fluid communication with the interior of the first component reservoir, and wherein the outlet end of the first tube is in fluid communication with the first mixer inlet. There is also a second component metering system which includes a second component reservoir having an interior, and a second peristaltic pump means, comprising a second tube having an inlet end and an outlet end. There is a second peristaltic pump head sufficiently disposed along the length of the second tube, between its inlet end and the outlet end, so that when the second peristaltic pump head is operational, it causes the fluid present in the interior of the portion of the second tube that is disposed between the second peristaltic pump head and the inlet end of the second tube to exist at a third pressure, and simultaneously causes the fluid present in the interior of the portion of the second tube that is disposed between the second peristaltic pump head and the outlet end of the second tube to exist at a fourth pressure that is higher than the third pressure. The inlet end of the second tube is in fluid communication with the interior of the second component reservoir, and the outlet end of the second tube is in fluid communication with the second mixer inlet. There is a mixer effluent line, having a first end portion and a second end portion, wherein the first end portion of the mixer effluent line is in fluid communication with the mixer outlet. There is also an atomizing nozzle having a fluid inlet, wherein the fluid inlet of the atomizing nozzle is in fluid communication with the second end portion of the mixer effluent line. The first pressure, may be higher or lower than the third pressure, by any amount of pressure, and the second pressure may be higher or lower than the fourth pressure, by any amount of pressure.

### BRIEF DESCRIPTION OF THE DRAWINGS

FIG. 1 shows a schematic representation of a system according to the invention.

### DETAILED DESCRIPTION

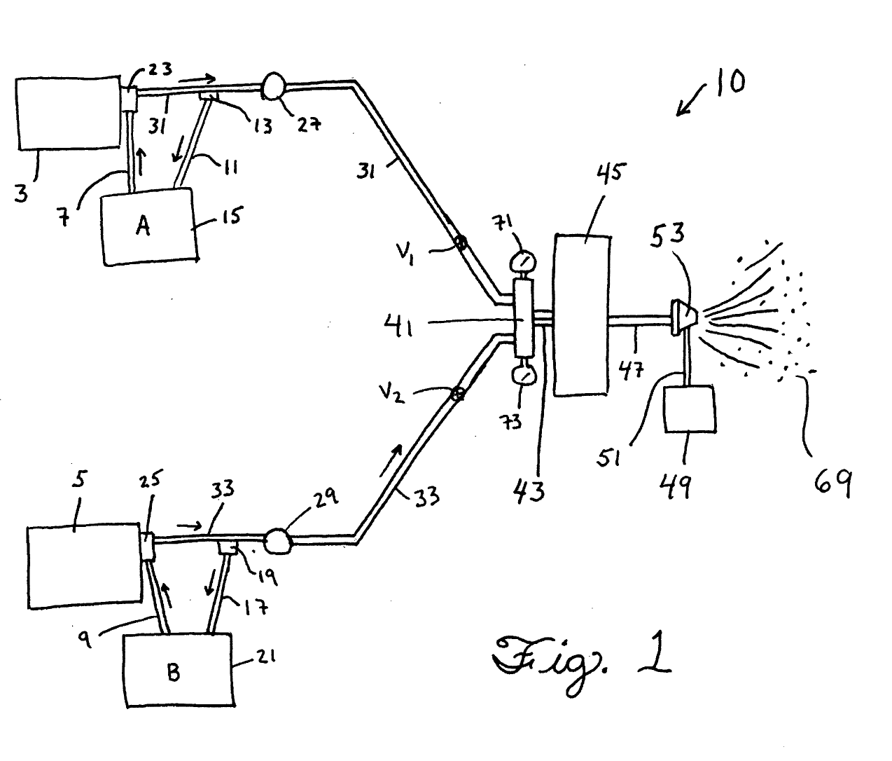

Referring to the drawings and initially to FIG. 1 there is shown a block schematic diagram of a system 10 for providing a curable polymeric mixture according to the invention. In this embodiment are shown a first peristaltic pump head 23 and a second peristaltic pump head 25, each of which are driven by a first pump drive 3 and a second pump drive 5, respectively. Peristaltic pumps are known in the art to be a type of positive displacement pump useful for pumping fluids. In one configuration, referred to as rotary peristaltic pumps, the fluid to be pumped is contained within a flexible tube fitted inside a circular pump casing. In the rotary configuration, a roller with a number of “rollers”, “shoes” or “wipers” as they may be called are attached to the external circumference compresses the flexible tube. As the rotor turns, the part of tube under compression closes, thus forcing the fluid to be pumped to move through the tube. Additionally, as the tube opens to its natural state after the passing of the cam, fluid flow is induced to the pump. This process is called persistalsis, and is used by Nature herself in biological systems such as the intestines. In an alternative embodiment, peristaltic pumps are made to operate in a linear fashion, as is generally known in the art. Peristaltic pumps thus typically have an inlet portion where fluid is admitted, and an outlet portion where the fluid being pumped is caused to exit the pump.

The peristaltic pump drives 3, 5 typically consist of an electric motor with associated reducing gearings, which enable the user to adjust the speed of rotation of the pump heads which are attached to them. In one embodiment of the present invention, the pump drives and heads are preferably those made by Rolatec Pump Company of North Oaks, Minn. having model number MP-V30. However, the present invention is not limited to the use of such drive-head combinations, but may be constructed and practiced using a wide range of peristaltic pumps which are commercially available. It is preferred that each pump be equipped with an electrical overload protection, such as a fuse, to act as a safety to stop pump operations if fluid pressure is greater than the desired amount, to prevent the bursting of conduits in the event of an over-pressure situation, for cases in which pressure relief valves are not used.

A system according to the invention has at least one, and preferably two peristaltic pumps as essential components. The first peristaltic pump head 23 has a first inlet line 7, which is in fluid contact with the contents contained in the first component reservoir 15, which may contain the “A” component of a reactive mixture. The contents of the first component reservoir 15 may or may not be heated or cooled, to a termperature different than that of the ambient surroundings, depending upon the component. (A convenient heating means for heating components used in providing coatings according to the invention is the DPCH10 Heavy Duty Drum Heater available from barrel Accessories and Supply Company of University park, Ill.). The first peristaltic pump head 23 also has a first feed line 31 attached to its outlet portion, which ultimately may terminate in a junction block 41 (which may comprise a manifold) or a mixer 45. Along the first feed line 31 is preferably disposed a pressure relief valve 13, which may be set to any desired pressure level such that when the set pressure level is exceeded, the valve is opened to allow the exiting of fluid material from the first feed line 31 and back into the first component reservoir 15 via first return line 11. A pressure relief valve useful in this regard is model number C46BABVSSEE made by the Wanner Engineering of Minneapolis, Minn. It is of benefit to have a first pressure gauge 27 disposed at any point along the length of the first feed line 31, and to optionally locate another pressure gauge at any other point therealong, to enable monitoring of pressure differences in the line during operation of the system 10.

In one embodiment, the first feed line 31 is comprised of a soft, ester-based polyurethane peristaltic tubing, such as part number 5792K42 available from McMaster-Carr of Elmhurst, Ill., and has any inner diameter in the range of between about three and fifty millimeters or larger; however, any tubing that is useful as an element of a peristaltic pump may be employed.

In one embodiment, the pressure in the first feed line 31 is maintained at any pressure in the range of between about one pounds per square inch (psi) and 80 psi preferably by controlling the speed of rotation of the rotary element(s) of the first peristaltic pump head 23. In another embodiment, the pressure in the first feed line 31 is maintained at any pressure in the range of between about ten pounds per square inch (psi) and 60 psi. For purposes of this specification and the claims appended hereto, these ranges, and any other ranges herein set forth, shall be construed as also explicitly including every possible other expressable range therebetween. In this instant case, for purposes of example and not delimitive whatsoever, such ranges include, without limitation, the ranges 5-50 psi, 5-80 psi, 5-10 psi, 10-60 psi, 10-80 psi, 10-30 psi, 20-50 psi, 20-80 psi, 30-40 psi, 30-70 psi, and any range of any span and any initial and terminal value in the range of one to 80 psi.

There is also a second peristaltic pump head 25 which has a second inlet line 9, which is in fluid contact with the contents contained in the second component reservoir 21, which may contain the “B” component of a reactive mixture. The contents of the second component reservoir 21 may or may not be heated or cooled, to a termperature different than that of the ambient surroundings, depending upon the component. The second peristaltic pump head 25 also has a second feed line 33 attached to its outlet portion, which ultimately may terminate in a junction block 41 (which may comprise a manifold) or a mixer 45. Along the second feed line 33 is preferably disposed a pressure relief valve 19, which may be set to any desired pressure level such that when the set pressure level is exceeded, the valve is opened to allow the exiting of fluid material from the second feed line 33 and back into the second component reservoir 21 via second return line 17. It is of benefit to have a second pressure gauge 29 disposed at any point along the length of the second feed line 33, and to optionally locate another pressure gauge at any other point therealong, to enable monitoring of pressure differences in the line during operation of the system 10.

The in-line safety/recirculation pressure relief valves 13, 19 are an important aspect of a system according to the invention. In addition to the pumps' internal fuse breaker, which will trip when 1.5 amperes of current is reached and stop the pumps when the pressure in the tubing is about 85 to 100 psi, the relief valves 13, 19 can be manually set to trip at any pressure in the range of between about 50 psi to about 130 psi, directly downstream of the pumps' output. When one of these valves reaches an over-pressured situation, the fluid is caused to flow back to the component reservoir, thus relieving the pressure in the tubing. This is of benefit when it is desired to stop spraying material, and the valves V₁, and V₂ (as described below) are used to stop the flow of the component(s) from the reservoir(s) to the spray nozzle, for in this situation, the relief valves merely divert the material(s) back into the reservoir(s). This keeps the material(s) being pumped in a mixed state and at a constant temperature; hence the system of the invention also functions as a mixing apparatus.

In one embodiment, the second feed line 33 is comprised of a soft, ester-based polyurethane peristaltic tubing, such as part number 5792K42 available from McMaster-Carr of Elmhurst, Ill., and has any inner diameter in the range of between about three and fifty millimeters or larger; however, any tubing that is useful as an element of a peristaltic pump may be employed. In one embodiment, the pressure in the second feed line 33 is maintained at between about 1 pounds per square inch (psi) and about 80 psi, preferably by controlling the speed of rotation of the rotary element(s) of the second peristaltic pump head 25. In another embodiment, the pressure in the second feed line 33 is maintained at any pressure in the range of between about ten pounds per square inch (psi) and 60 psi. Again, for purposes of example and not delimitive whatsoever, such ranges include, without limitation, the ranges 5-50 psi, 5-80 psi, 5-10 psi, 10-60 psi, 10-80 psi, 10-30 psi, 20-50 psi, 20-80 psi, 30-40 psi, 30-70 psi, and any range of any span and any initial and terminal value in the range of one to 80 psi.

The first feed line 31 contains the chemical component that is contained in the first component reservoir 15, under pressure as described above, and the second feed line 33 contains the chemical component that is contained in the second component reservoir 21, under pressure as described above. The first feed line 31 and second feed line 33 may both terminate in a junction block 41, which may comprise manifold. The purpose of the junction block, when used, is to turn the two separate lines 31 and 33 into a single feed 43, which is then provided to a mixer 45, which may be a static mixer or a dynamic mixer equipped with an impeller or other dispersing or mixing means, as such are known in the art. As mentioned, it may be desirable to have a second pressure gauge disposed along the feed lines 31, 33 and in this regard it is possible to locate such pressure gauges in the junction block 41. Thus, the pressure gauge 71 measures the pressure of the first feed line 31, and the pressure gauge 73 measures the pressure of the second feed line 33, at the junction block. These gauges are helpful in knowing pressure in the system in many instances, such as when the ballcock valves V₁ and V₂ (Series 550 valves, 550-100hf-aa-01 from TAH Industries, Inc. Robbinsville, N.J.) are open or closed, as in takedown of the system, or changing out colors or materials from the reservoirs 15, 21, adjusting pump speeds, etc.

The single feed 43 may comprise a single tube which allows the A and B components to contact one another prior to their introduction into the mixer 45. In another embodiment, the single feed 43 comprises a dividing wall within its inner confines which precludes the A and B components from coming into contact with one another prior to their entry to the mixer 45.

The mixer 45 is a chamber in which mixing to the contents of the first feed line 31 and second feed line 33 takes place. It may be a static mixer, as such are well-known in the art, or it may be a dynamic mixer, such as model no. 442-M1-ATSEE (Series 42) made by TAH Industries, Inc. When the mixer 45 is a static mixer, the force of the pumps 23 and 25 drives the materials through the mixer and into the mixer effluent line 47, which provides its contents to the atomizer nozzle 53. For instances where the mixer 45 is a dynamic mixer, the force to move the materials through the effluent line 47 (Blue Max High Pressure Spray Hose, from Graco of Minneapolis, Minn. or equivalent) may come from the energy of the mixer itself. In any event, the atomizer nozzle 53 is provided with compressed air or other gas from a compressed air reservoir or compressor 49, which is conveyed through compressed gas feed line 51. which may be an ordinary air hose made of PVC or like materials known as being useful in pneumatic hoses. This causes the mixture comprising the A and B components to be dispersed into droplets, which collectively comprise a spray 69, which spray 69 may then be conveniently applied to any surface that is desired to have a coating produced from components A and B on it. Such surfaces include without limitation: walls, floors, truck beds, trailers, railcars, automobile frames, construction frames, pond-liners, architectural decks, wheeled-vehilcles, cargo containers, and literally any surface whose corrosion properties, wearability, or physical appearance may be enhanced by a coating.

The atomizer nozzle 53 may be any nozzle known in the art that is suitable for providing a spray of a viscous liquid, preferably, but not necessarily under the influence of a compressed gas, such as compressed air, or in the case of mistures which are reactive with oxygen or water, dry nitrogen. In one preferred embodiment, the atomizer nozzle is model number 161-224AA-3 made by TAH Industries, Inc. of Robbinsville, N.J., used in combination with the high flow spray air cap, model 171-AN-F2 also from TAH Industries, Inc. Compressed air supplied to the atomizer nozzle 53 may be supplied at any pressure at which the nozzle is capable of providing a spray.

Use of a system according to the invention is advantageous over methods in the prior art, in which an A component is mixed with a B component using conventional mixing equipment and then the mixture is subsequently spread manually on a floor surface. In contrast, a coating applied using a system according to the instant invention has more time to cure on the surface to which it has been directed, for in the prior art method the material begins to cure immediately upon mixing, in the bucket or other vessel. Having more time to cure in its final intended resting position translates into a coating of increased integrity. Further, when using a system according to the invention the concept of “pot life” is no longer a consideration. This alleviates the need to have as many employees or other personnel to carry out the coating process and saves on labor costs. In addition, when mixing materials for floor coatings according to known methods, there is always some material left over that is not used, which constitutes a waste which is costly and must also be disposed of in accordance with environmentally-acceptible means. Through use of the present invention about 85% of this waste is eliminated.

The peristaltic pump heads and drive means preferably are each equipped with remote on/off switches to control pump flow. Since peristaltic pumps are self-priming, they can be permitted to run dry without fear of seizing or damaging internal components. Since there is no fluid communication between the pump components and the fluid contained in the tubing, A or B, there is no chemical contamination of the pump's components possible. Changing color of coatings or identity of coatings, using a system 10 according to the invention, is as easy as changing the feed lines 31 and 33 with new tubing, and connecting a different component A or B, or both, at the inlet side of the respective peristaltic pump.

Although the various conduits 7, 9, 11, 17, 31, 33, 43, 47 are shown in FIG. 1 as being of one particular proportion to one another as regards their lengths, the present invention includes any length of any of these conduits, as the drawing in FIG. 1 is intended to illustrate diagrammatically some of the essential components of the invention and their qualitative connection and cooperation with one another. For example, it may be desirable in many instances to have the effluent line 47 to be of much longer length than the feed lines 31, 33, for instances in which the atomizer nozzle is attached to a hand-held spray gun, which is held by walking operator. The lengths of each of the aforesaid conduits may vary, depending upon the end use application; their exact lengths are not critical to the principles of the invention. In one embodiment, it is preferred, however, that the feed lines 31, 33 do not each exceed about three meters in length. In one embodiment, it is preferred that the effluent line 47 does not exceed about twelve meters in length, with a length of about eight meters being preferred. Preferably, all of the various conduits 7, 9, 11, 17, 31, 33, 43, 47 are thermally-insulated.

Through use of the system 10 described above, it is possible to maintain a wide range of pressures in either of the feed lines 31, 33, and to cause the relative ratios of pumping speed of the pump heads 23, 25 to be variable with respect to one another in any ratio.

The present system 10 is useful for providing a wide range of coatings, by providing a spray of a reactive mixture which itself was formed from mixing two components, an A component, and a B component. The A component is generally neat liquid polyisocyanate or a mixture including any organic polyisocyanate in a suitable vehicle, such as dissolved in an ester, polyether or other non-reactive vehicle or solvent, and the B component is any material which is capable of reacting with an organic polyisocyanate selected to be included in the A component, to yield a polymeric material that is capable of functioning as a coating. Suitable B components include all poly-ols and polyamines known to those of ordinary skill in the art to be useful in providing polymers useful as coating materials when mixed with an organic polyisocyanate.

In a preferred embodiment, the A component comprises an organic polyisocyanate, and may contain any number of suitable aromatic or aliphatic-based polyisocyanates, such as toluene di-isocyanate, di-phenylmethane di-isocyanates, isocyanate containing prepolymers or quasi-prepolymers. These are standard isocyanate materials known to those skilled in the art. Preferred examples include MDI-based quasi-prepolymers such as those available commercially as RUBINATE® 9480, RUBlNATE® 9484, and RUBINATE® 9495 from Huntsman International, LLC. The isocyanates employed in component A can also be selected from aliphatic isocyanates of the type described in U.S. Pat. No. 4,748,192. These include aliphatic di-isocyanates and, more particularly, are the trimerized or the biuretic form of an aliphatic di-isocyanate, such as hexamethylene di-isocyanate (“HDI”), or the bi-functional monomer of the tetraalkyl xylene di-isocyanate, such as the tetramethyl xylene di-isocyanate. Cyclohexane di-isocyanate is also to be considered a useful aliphatic isocyanate. Other useful aliphatic polyisocyanates are described in U.S. Pat. No. 4,705,814. They include aliphatic di-isocyanates, for example, alkylene di-isocyanates with 4 to 12 carbon atoms in the alkylene radical, such as 1,12-dodecane di-isocyanate and 1,4-tetramethylene di-isocyanate. Also useful are cycloaliphatic di-isocyanates, such as 1,3 and 1,4-cyclohexane di-isocyanate as well as any mixture of these isomers, 1-isocyanato-3,3,5-trimethyl-5-isocyanatomethylcyclohexane (isophorone di-isocyanate); 4,4′-,2,2′- and 2,4′-dicyclohexylmethane di-isocyanate as well as the corresponding isomer mixtures, and the like. All patents mentioned in this specification are herein incorporated by reference thereto.

The process of providing a coating using a system according to the present invention may include production of a foamed product as a coating, such as a foamed polyurea. A wide variety of aromatic polyisocyanates may also be used to form a foamed polyurea elastomer according to the present invention. Typical aromatic polyisocyanates include p-phenylene di-isocyanate, polymethylene polyphenylisocyanate, 2,6-toluene di-isocyanate, dianisidine di-isocyanate, bitolylene di-isocyanate, naphthalene-1,4-di-isocyanate, bis(4-isocyanatophenyl)methane, bis(3-methyl-3-iso-cyanatophenyl)methane, bis(3-methyl-4-isocyanatophenyl)methane, and 4,4′-diphenylpropane di-isocyanate. Other aromatic polyisocyanates used in the practice of the invention are methylene-bridged polyphenyl polyisocyanate mixtures which have a functionality of from about 2 to about 4. These latter isocyanate compounds are generally produced by the phosgenation of corresponding methylene bridged polyphenyl polyamines, which are conventionally produced by the reaction of formaldehyde and primary aromatic amines, such as aniline, in the presence of hydrochloric acid and/or other acidic catalysts. Known processes for preparing polyamines and corresponding methylene-bridged polyphenyl polyisocyanates therefrom are described in the literature and in many patents, for example, U.S. Pat. Nos. 2,683,730; 2,950,263; 3,012,008; 3,344,162 and 3,362,979. Usually methylene-bridged polyphenyl polyisocyanate mixtures contain about 20 to about 100 weight percent methylene di-phenyl-di-isocyanate isomers, with the remainder being polymethylene polyphenyl di-isocyanates having higher functionalities and higher molecular weights. Typical of these are polyphenyl polyisocyanate mixtures containing about 20 to about 100 weight percent di-phenyl-di-isocyanate isomers, of which about 20 to about 95 weight percent thereof is the 4,4′-isomer with the remainder being polymethylene polyphenyl polyisocyanates of higher molecular weight and functionality that have an average functionality of from about 2.1 to about 3.5. These isocyanate mixtures are known, commercially available materials and can be prepared by the process described in U.S. Pat. No. 3,362,979. One preferred aromatic polyisocyanate is methylene bis(4-phenylisocyanate) or MDI. Pure MDI, quasi-prepolymers of MDI, modified pure MDI, etc. are useful to prepare suitable elastomers. Since pure MDI is a solid and, thus, often inconvenient to use, liquid products based on MDI or methylene bis(4-phenylisocyanate) are also useful herein. U.S. Pat. No. 3,394,164 describes a liquid MDI product. More generally, uretonimine modified pure MDI is included also. This product is made by heating pure distilled MDI in the presence of a catalyst. The liquid product is a mixture of pure MDI and modified MDI. Of course, the term isocyanate also includes quasi-prepolymers of isocyanates or polyisocyanates with active hydrogen containing materials.

Any of the isocyanates mentioned above may be used as the isocyanate component in the present invention, either alone or in combination with other aforementioned isocyanates. Other polyisocyanates and mixtures including polyisocyanates may be employed as the A side component in a process using the system of the present invention. In one embodiment, a preferred aliphatic isocyanate is ORDCLR10, available from ORPC Manufacturing of Ripon, Wis.

Suitable materials for the second (“B”) component, or for inclusion in a mixture to be used as the “B” component include any material that is capable of reacting with an organic isocyanate group present on a material listed above which qualifies as a component A isocyanate material, including all known poly-ols and polyamines, whether aliphatic or aromatic, straight-chain, branched or cyclic. Suitable polyamines include ethylene diamine, 1,2- and 1,3-diaminopropane, 1,4-diaminobutane, 1,6-diaminohexane, isophorone diamine, isomer mixture of 2,2,4- and 2,4,4-trimethyl hexamethylene diamine, 2-methyl pentamethylene diamine, diethylene triamine, 1,3- and 1,4-xylene diamine, α, α, α′, α′,-tetramethyl-1,3- and -1,4-xylylene diamine and 4,4-diaminodicyclohexyl methane. Other compounds to be considered as suitable diamines include hydrazine, hydrazine hydrate and substituted hydrazines, such as N-methyl hydrazine, N,N′-dimethyl hydrazine and homologues thereof, as well as acid dihydrazides, adipic acid, β-methyl adipic acid, sebacic acid, hydracrylic acid and terephthalic acid, semicarbazidoalkylene hydrazides, such as β-semicarbatidopropanoic acid hydrazide, semicarbazidoalkylene carbazine esters, such as 2-semicarbazidoethyl carbazine ester or aminosemicarbazide compounds, such as β-aminoethyl semi-carbazidocarbonate. One preferable class of materials suitable for use as polyamines from which a polymeric coating composition may be produced according to the invention using a polyisocyanate material described above are the aspartic or aspartate esters, described in one or more of the following US Patents, all of which are herein incorporated by reference thereto: U.S. Pat. Nos. 6,790,925; 6,774,207; 6,774,206; 6,737,500; 6,590,066; 6,458,293; 6,355,829; 6,183,870; 6,169,140; 5,847,195; 5,736,604; 5,733,967; 5,652,301; 5,559,204; 5,516,873; and 5,489,704. However, one of ordinary skill in the art appreciates that many different di- or poly-amines are useful within a process using a system according to the present invention, depending on the particular application and the known physical properties of the polymer produced. Polyamines and poly-ols can be collectively referred to as isocyanate-reactive materials. In one embodiment, when the isocyanate component is the aliphatic isocyanate ORDCLR10 from ORPC Manufacturing, the preferred B component is the aspartic ester product ORDCLR20-B, available from ORPC Manufacturing of Ripon, Wis. Such combinations yield durable polyurea coatings when applied using a system according to the present invention.

Thus, the compositions of the A and the B components can vary widely, depending upon end use application, as is known in the art. However, a system according to the present invention is robust from the standpoint that it is capable of producing polymeric coatings from any components comprising an organic polyisocyanate and an isocyanate-reactive material, provided that the A component and B component are capable of being pumped through a peristaltic pump. In addition to polyurethane-based and polyurea-based coatings, this also includes any plural component epoxy or acrylic coating materials. Further, the system of the invention can be used to provide a spray of single component coatings, by loading the coating material into either the first component reservoir, second component reservoir, or both, providing compressed air to the nozzle and pumping the material from the component reservoir(s) through the system. Typical single component coatings or materials include those useful for providing paint coatings, viscous stucco and above-grade coatings including TREMCO® HORIZON waterproofing product, and moisture cure single-component polyurethanes.

Towards ensuring pumpability, the means for heating the component reservoirs (which may be five-gallon pails) is important in that it comprises heating bands which are exterior to the interior of the component reservoirs, which ensures that the components will not overheat and have hot spots which can cause local degradation, as can occur when immersion heaters are employed. It is preferable to maintain the materials in the component reservoirs at a temperature at or below about 75 degrees centigrade.

Throughout this specification reference has been made to the words “fluid communication”. In general, fluid communication, for example, between the tube element of a peristaltic pump subcombination and a junction block element, means that the tube is connected to the junction block so that the interior of the tube is in fluid communication with the interior of the junction block. This may include the use of conventional fasteners commonly used to join tubings, hoses, etc. to manifolds, such as by brass fittings, compression fittings, barbs, swaged connections, etc. as such means are well known in the art. When an inlet portion of a tube that is part of a peristaltic pump subcombination is said to be in fluid communication with a component reservoir, this may simply mean that the hose end is hanging inside a five-gallon bucket, sufficiently to suck up any liquid chemical component that is present in the bucket. It may also mean that the hose end is rigidly affixed either to the wall or floor portion or other portion of the reservoir by conventional fittings as described above, or as by welding, etc., as these are all means for causing the tube end (hose) to be in fluid communication with the interior of the reservoir. Clearly however, one of ordinary skill recognizes that the fittings which connect the conduits between the various elements of a system according to the invention, must in general be airtight and leak-proof and capable of withstanding pressures in the range of between about one to ten atmospheres of pressure.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. This includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claims so modified. This also includes combination of the features and/or limitations of one or more of the independent claims with features and/or limitations of another independent claims to arrive at a modified independent claim, with the remaining dependent claims in their original text being read and applied to any independent claim so modified. Accordingly, the presently disclosed invention is intended to cover all such modifications and alterations, and is limited only by the scope of the claims which follow.

I claim:

1) A system useful for providing coatings to surfaces, which comprises:
a) a mixer means, said mixer having a first mixer inlet and a second mixer inlet, wherein said mixer means is adapted to receive two separate chemical feeds and permit their admixture, said mixer further comprising a mixer outlet;
b) a first component metering system comprising;
i) a first component reservoir having an interior;
ii) a first peristaltic pump means, comprising a first tube having an inlet end and an outlet end, and a first peristaltic pump head sufficiently disposed along the length of said first tube, between its inlet end and said outlet end, so that when said first peristaltic pump head is operational, it causes the fluid present in the interior of that portion of the first tube that is disposed between said first peristaltic pump head and the inlet end of said first tube to exist at a first pressure, and simultaneously causes the fluid present in the interior of the portion of the first tube that is disposed between said first peristaltic pump head and the outlet end of said first tube to exist at a second pressure that is higher than said first pressure,
wherein said inlet end of said first tube is in fluid communication with the interior of said first component reservoir, and wherein said outlet end of said first tube is in fluid communication with said first mixer inlet;
c) a second component metering system comprising;
i) a second component reservoir having an interior;
ii) a second peristaltic pump means, comprising a second tube having an inlet end and an outlet end, and a second peristaltic pump head sufficiently disposed along the length of said second tube, between its inlet end and said outlet end, so that when said second peristaltic pump head is operational, it causes the fluid present in the interior of the portion of the second tube that is disposed between said second peristaltic pump head and the inlet end of said second tube to exist at a third pressure, and simultaneously causes the fluid present in the interior of the portion of the second tube that is disposed between said second peristaltic pump head and the outlet end of said second tube to exist at a fourth pressure that is higher than said third pressure,
wherein said inlet end of said second tube is in fluid communication with the interior of said second component reservoir, and wherein said outlet end of said second tube is in fluid communication with said second mixer inlet;
d) a mixer effluent line, having a first end portion and a second end portion, wherein said first end portion of said mixer effluent line is in fluid communication with said mixer outlet;
e) an atomizing nozzle having a fluid inlet, wherein said fluid inlet of said atomizing nozzle is in fluid communication with said second end portion of said mixer effluent line.

2) A system according to claim 1, wherein said atomizing nozzle further includes an inlet for receiving compressed air, said system further comprising: f) a source of compressed air in fluid communication with said inlet for receiving compressed air.

3) A system according to claim 1 wherein said first component metering system further includes: iii) a pressure relief valve in fluid communication with said first tube at a point where it experiences said second pressure, said pressure relief valve comprising an exit port; and iv) a return line conduit having a first end portion and a second end portion, said first end portion of said return line conduit being attached to the exit port of said relief valve and wherein said second end portion of said return line conduit is disposed to be within the interior of said first component reservoir.

4) A system according to claim 3 wherein said pressure relief valve is set to open at any pressure in the range of between about 50 psi to about 130 psi, including all expressible ranges therebetween.

5) A system according to claim 3 wherein said second component metering system further includes: iii) a second pressure relief valve in fluid communication with said second tube at a point where it experiences said fourth pressure, said second pressure relief valve comprising an exit port; and iv) a second return line conduit having a first end portion and a second end portion, said first end portion of said second return line conduit being attached to the exit port of said second relief valve and wherein said second end portion of said return line conduit is disposed to be within the interior of said second component reservoir.

6) A system according to claim 5 wherein said pressure relief valve is set to open at any pressure in the range of between about 50 psi to about 130 psi, including all expressible ranges therebetween.

7) A system according to claim 1 wherein at least one of said peristaltic pump means is driven by an electrical motor having a circuit which includes a fuse which breaks the circuit at a current flow of any value selected from the group consisting of: 1.0 amperes, 1.1 amperes, 1.2 amperes, 1.3 amperes, 1.4 amperes, and 1.5 amperes.

8) A system according to claim 1 wherein at least one of said peristaltic pump means is a rotary peristaltic pump.

9) A system according to claim 1 wherein at least one of said peristaltic pump means is a linear peristaltic pump.

10) A system according to claim 1 wherein said mixer means is a static mixer.

11) A system according to claim 1 wherein said mixer means is a dynamic mixer.

12) A system according to claim 10 wherein said first mixer inlet and said second mixer inlet are disposed on a manifold.

13) A process for producing a gaseous polymer precursor comprising the steps of:
a) providing a system according to claim 1;
b) providing an organic polyisocyanate in said first component reservoir;
c) providing an isocyanate-reactive component in said second component reservoir;
d) providing a compressed gas to said atomizer nozzle;
e) energizing said first peristaltic pump means at a speed sufficient to enable the contents of said first component reservoir to enter said atomizer nozzle, and simultaneously energizing said second peristaltic pump means at a speed sufficient to enable the contents of said second component reservoir to enter said atomizer nozzle so as to cause a spray to be emitted from said atomizer nozzle,
wherein said spray contains said organic polyisocyanate and said isocyanate-reactive component in substantially stoichiometric amounts.

14) A process according to claim 13, wherein said isocyanate-reactive component comprises a material selected from the group consisting of: an aspartic ester and a polyaspartate.

15) A process for producing a polymeric coating which comprises the steps of:
a) providing a system according to claim 1;
b) providing an organic polyisocyanate in said first component reservoir;
c) providing an isocyanate-reactive component in said second component reservoir;
d) providing a compressed gas to said atomizer nozzle;
e) energizing said first peristaltic pump means at a speed sufficient to enable the contents of said first component reservoir to enter said atomizer nozzle, and simultaneously energizing said second peristaltic pump means at a speed sufficient to enable the contents of said second component reservoir to enter said atomizer nozzle so as to cause a spray to be emitted from said atomizer nozzle,
wherein said spray contains said organic polyisocyanate and said isocyanate-reactive component in substantially stoichiometric amounts;
f) providing a substrate; and
g) orienting said atomizer nozzle sufficiently to cause a portion of said spray to impinge on said substrate.

16) A process according to claim 15, wherein said isocyanate-reactive component comprises a material selected from the group consisting of: an aspartic ester and a polyaspartate.
